(19) United States
(12) Patent Application Publication
(10) Pub. No.: US 2008/0114750 A1
(43) Pub. Date: May 15, 2008

(54) RETRIEVAL AND RANKING OF ITEMS UTILIZING SIMILARITY

(75) Inventors: Ashutosh Saxena, Stanford, CA (US); Jingwei Lu, Redmond, WA (US); Nimish Khanolkar, Kirkland, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/559,659

(22) Filed: Nov. 14, 2006

(51) Int. Cl. G06F 17/30

(52) U.S. Cl. 707/5; 707/E17.108

(57) ABSTRACT

The subject disclosure pertains to systems and methods for facilitating item retrieval and/or ranking. An original ranking of items can be modified and enhanced utilizing a Markov Random Field (MRF) approach based upon item similarity. Item similarity can be measured utilizing a variety of methods. An MRF similarity model can be generated by measuring of similarity between items. An original ranking of items can be obtained, where each document is evaluated independently based upon a query. For example, the original ranking can be obtained using a keyword search. The original ranking can be enhanced based upon similarity of items. For example, items that are deemed to be similar should have similar rankings. The MRF model can be used in conjunction with original rankings to adjust rankings to reflect item relationships.

### BACKGROUND

The amount of data and other resources available to information seekers has grown astronomically, whether as the result of the proliferation of information sources on the Internet, private efforts to organize business information within a company, or any of a variety of other causes. Accordingly, the increasing volume of available information and/or resources makes it increasingly difficult for users to review and retrieve desired data or resources. As the amount of available data and resources has grown, so has the need to be able to locate relevant or desired items automatically.

Increasingly, users rely on automated systems to filter the universe of data and locate, retrieve or even suggest desirable data. For example, certain automated systems search a set or corpus of available items based upon keywords from a user query. Relevant items can be identified based upon the presence or frequency of keywords within items or item metadata. Some systems utilize an automated program such as a web crawler that methodically navigates the collection of items (e.g., the World Wide Web). Information obtained by the automated program can be utilized to generate an index of items and rapidly provide search results to users. The index may be searched using keywords provided in a user query.

Standard keyword searches are often supplemented based upon analysis of hyperlinks to items. Hyperlinks, also referred to as links, act as references or navigation tools to other documents within the set or corpus of document items. Generally, large numbers of links to an item indicate that the item includes valuable information or data and is recommended by other users. Certain search tools analyze relevance or value of items based upon the number of links to that item. However, link analysis is only available for items or documents that include such links. Many valuable resources (e.g., books, newsgroup discussions) do not regularly include hyperlinks. In addition, it takes time for new items to be identified and reviewed by users. Accordingly, newly available documents may have minimal links and therefore, may be underrated by search tools that utilize link analysis.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the provided subject matter concerns facilitating item retrieval and/or ranking. Frequently, search or retrieval systems utilize keywords to identify desirable items from a set or corpus of items. However, keyword searches can miss relevant items, particularly when exact keywords do not appear within the item. Additionally, items that are closely related may have widely disparate rankings if one item utilizes query keywords infrequently, while the other item includes multiple instances of such keywords.

The systems and methods described herein can be utilized to facilitate item retrieval and/or ranking based upon similarity between items. As used herein, similarity is a measure of correlation of concepts and topics between two items. Item similarity can be used to enhance traditional search systems, delivering items not found using keyword searches and improving accuracy of item ranking or ordering. At initialization, various algorithms or methods for measuring similarity can be utilized to determine similarity for pairs of items. Measured similarity among the items of the corpus can be represented by a similarity model using a Markov Random Field. The similarity model can be used in with search systems to enhance search results.

In response to a query, an ordered set of items can be identified using an available search algorithm. The ordered set of items can be enhanced and supplemented based upon the similarities demonstrated in the similarity model. The original ordered set can be reevaluated in conjunction with item similarity measures to generate a final ordered set. For instance, items that are deemed similar should have similar ranks within the ordered set. The final ordered set can also include items not identified by the initial search algorithm.

Generation of a similarity model can be facilitated using data clustering algorithms or classification of items. If the corpus includes a large number of items, measurement of similarity for each possible pair of items within the corpus can prove time consuming. To increase speed, items can be separated into clusters using available clustering algorithms. Alternatively, items can be subdivided into categories using a classification system. In this scenario, the similarity model can represent relationships between clusters or categories of items. Consequently, the number of similarity computations can be reduced, decreasing time required to build the Markov Random Field similarity model.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a system for facilitating search and ranking of documents in accordance with an aspect of the subject matter disclosed herein.

FIG. 2 illustrates a methodology for searching a set of documents in accordance with an aspect of the subject matter disclosed herein.

FIG. 3 is a block diagram of a system for facilitating similarity-based search and ranking of documents in accordance with an aspect of the subject matter disclosed herein

FIG. 4 is a block diagram of a system for generating and updating a similarity model in accordance with an aspect of the subject matter disclosed herein.

FIG. 5 is a graph illustrating the relationship between term weight and term frequency in measuring document similarity.

FIG. 6 is an illustration of an exemplary Markov Random Field graph in accordance with an aspect of the subject matter disclosed herein.

FIG. 7 is a graph illustrating a Laplacian distribution for a one-dimensional variable.

FIG. 8 illustrates a methodology for generating a similarity model in accordance with an aspect of the subject matter disclosed herein.

FIG. 9 illustrates an alternative methodology for generating a similarity model in accordance with an aspect of the subject matter disclosed herein.

FIG. 10 illustrates another alternative methodology for generating a similarity model in accordance with an aspect of the subject matter disclosed herein.

FIG. 11 is a schematic block diagram illustrating a suitable operating environment.

FIG. 12 is a schematic block diagram of a sample-computing environment.

### DETAILED DESCRIPTION

The various aspects of the subject matter disclosed herein are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The word “exemplary” is used herein to mean serving as an example, instance, or illustration. The subject matter disclosed herein is not limited by such examples. In addition, any aspect or design described herein as “exemplary” is not necessarily to be construed as preferred or advantageous over other aspects or designs.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Conventional keyword search tools can miss relevant and important documents. The terms “items” and “documents” are used interchangeably herein to refer to items, text documents (e.g., articles, books, and newsgroup discussions), web pages and the like. Typically, search tools evaluate each document independently, generating a rank or score and identifying relevant documents based solely upon the contents of individual documents. Searches based upon a limited set of keywords may be unsuccessful in locating or accurately ranking documents that are on topic if such documents use different vocabularies and/or fail to include the keywords. Natural languages are incredibly rich and complicated, including numerous synonyms and capable of expressing subtle nuances. Consequently, two documents may concern the same subject or concepts, yet depending upon selected keywords, only one document may be returned in response to a user query. For example, a query for “Sir Arthur Conan Doyle” should return documents or items related to the famous author. However, documents that refer to his most famous character “Sherlock Holmes” without explicitly referencing the author by name would not be retrieved. Yet clearly, any such documents should be considered related to the query and returned or ranked among the search results.

Certain search tools seek to improve results by utilizing document hyperlinks. However, links may not be available for recently added documents. Additionally, if the user group is not relatively large, the document set may not include sufficient links to gauge document utility or relationships accurately. Furthermore, certain types of documents may not include links (e.g., online books, newsgroup discussions).

Many of these issues can be resolved or mitigated by utilizing document similarity to enhance searches. Document similarity provides an additional tool in the analysis of documents for retrieval. For instance, in the example described above, documents that discuss Sherlock Holmes are likely to be closely related to documents regarding Sir Arthur Conan Doyle. Accordingly, similarity can be used to provide documents that may not otherwise have been presented in the search results. Document similarity can be used to analyze the corpus of documents and relationships among the documents, rather than relying upon individual, independent evaluation of each document.

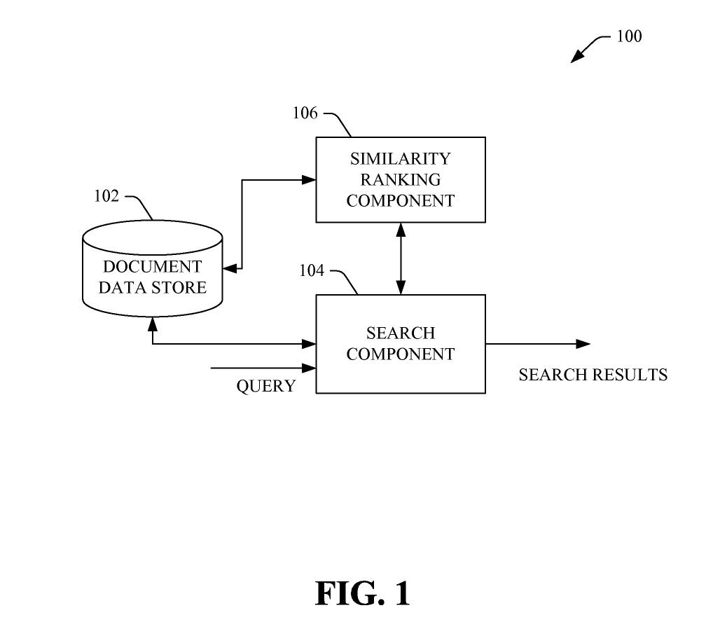

Referring now to FIG. 1, a system 100 for facilitating search and ranking of documents is illustrated. The system 100 can include a document data store 102 that maintains a set of documents. A data store, as used herein, refers to any collection of data including, but not limited to, a collection of files or a database. Documents can include any type of data regardless of format including web pages, text documents, word processing documents and the like.

A search component 104 can receive a query from a user interface (not shown) and perform a search based upon the received query. The search component 104 can search the document data store 102 to generate an initial ordered or ranked subset of documents. The search can be a simple keyword search of document contents. The search can also utilize hyperlinks, document metadata or any other data or techniques to develop an initial ranking of some or all of the documents. The initial ranking can include generating a score for some or all of the documents in the document data store 102 indicative of the computed relevance of the document with respect to the query. Documents that do not include keywords may be excluded from the ranking or ordered set of documents.

A similarity ranking component 106 can obtain the initial ranking of documents and generate an adjusted ranking or modified set of documents based at least in part upon similarity among the documents. The similarity ranking component 106 can be separate from the search component 104 as shown in FIG. 1. Alternatively, the similarity ranking component 106 can be included within a search component 104. The similarity ranking component 106 can include a similarity model that represents relationships among the documents. Prior to the query, the similarity model can be created based upon measured similarity between pairs of documents. Similarity measurement for a document pair can be based upon commonality of concepts or topics of the document pair. A variety of algorithms can be utilized to generate a similarity measurement or score. Similarity of documents can be represented using a Markov Random Field model, where each document constitutes a node of the graph, and distance between nodes corresponds to a similarity score for the pair of documents represented by the nodes. Similarity modeling is discussed in detail below.

Documents that do not appear in the initial ranking of documents retrieved for a query, particularly documents that lacked the query keywords, can be included in an adjusted ranking of documents based upon their marked similarity to documents included in the initial ranking. Accordingly, documents that may have been missed by the search component 104 can be added to the ordered set of search results. Ranks of documents added to the search results based upon similarity can be limited to avoid ranking such documents more highly than those documents returned by the initial search. Additionally, the similarity model can be used to improve ranking or ordering of documents within the initial search results. Generally, similar items should have comparable rankings.

The adjusted set of documents can be provided as search results. Either the search component 104 or the similarity ranking component 106 can provide the results to a user interface or other system. In particular, the adjusted rankings can be displayed using the user interface. Results can be provided as a list of links to relevant documents or any other suitable manner.

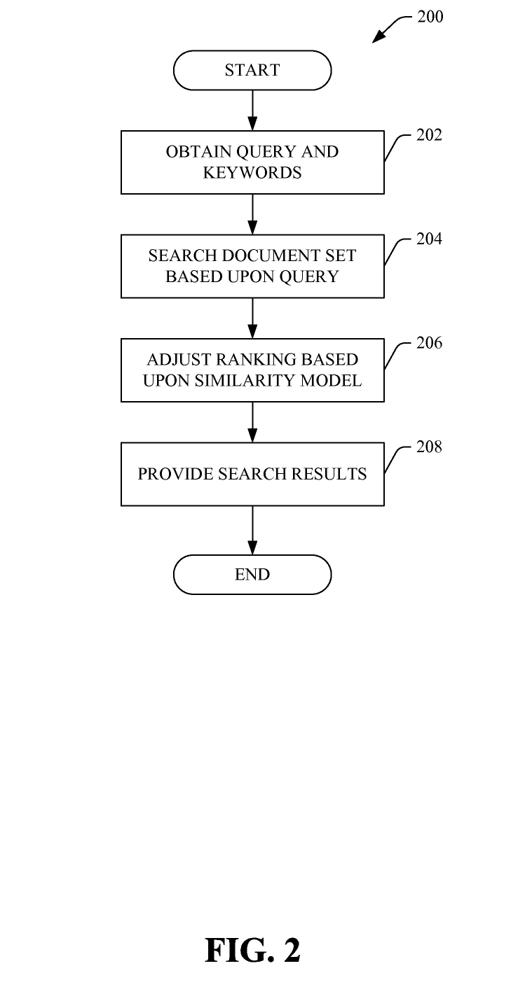

FIG. 2 illustrates a methodology 200 for searching and/or ranking a set of documents based upon an input query. At 202, an input query can be obtained. The query can be automatically generated or provided by a user through a user interface. The query can be parsed to obtain one or more keywords used to identify relevant documents from a set of documents. A search of the document set based upon the received query and/or keywords is performed at 204. The search can utilize any methodology or algorithm to locate and identify relevant documents. More particularly, a score can be generated for some or all of the individual documents of the document set, indicating the likely relevance of the documents. These scores can determine an initial ranking of documents based upon probable relevance.

The scores or rankings of the documents can be adjusted based upon document similarity at 206. Similar documents should receive similar ranks for a particular query. Discrepancies in document rankings can be identified and mitigated based upon a similarity model. In particular, a Markov Random Field similarity model can represent similarity of documents within the document set. Certain limitations can be applied in adjusting the ranks of documents. For example, documents that do not include the keywords of the search query may be ranked no higher than documents that actually include the keywords.

After adjustment of rankings, a set of search results can be provided to a user interface or other system at 208. The search results are defined based upon document rankings and can include the documents, document references or hyperlinks to documents. The order of search results should correspond to document rankings.

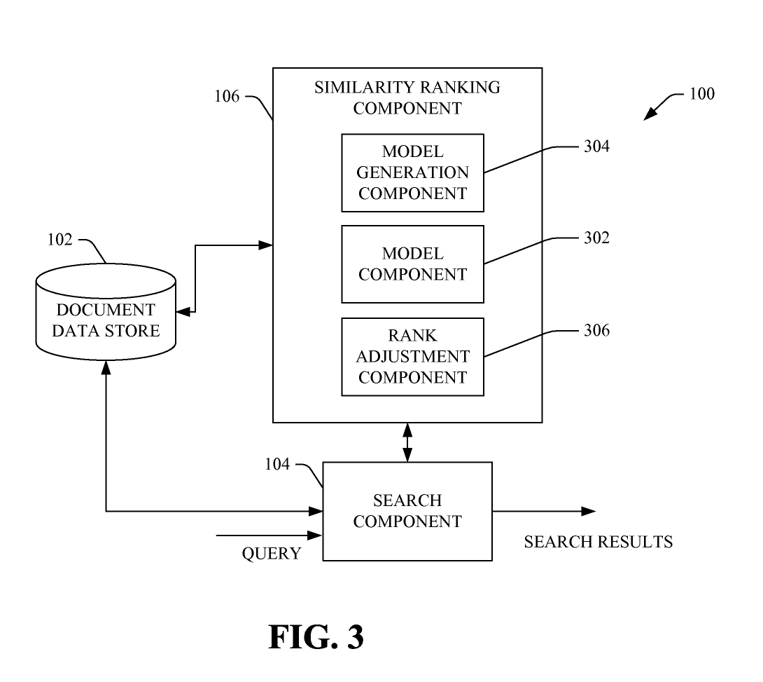

Referring now to FIG. 3, a system 100 for facilitating search and ranking of documents is illustrated in further detail. As shown, the similarity ranking component 106 can include a model component 302 that represents relationships of documents maintained in the document data store 102 and reflects the similarity between documents. A model generation component 304 can generate and/or update the model maintained by the model component 302.

The similarity ranking component 106 can also include a rank adjustment component 306 that utilizes the model component 302 in conjunction with initial rank or scores for the documents to generate adjusted document rankings. Rank adjustments can be computed utilizing a Second Order Cone Program (SOCP), a special case of Semi-Definite Programming (SDP). The similarity ranking component 106 can utilize a linear program, quadratic program, a SOCP or a SDP. Adjustment of rankings is described in detail below.

The model generation component 304 is capable of creating a Markov Random Field (MRF) model based upon similarity of documents within the document data store 102. Additionally, the model generation component 304 can rebuild or update the model periodically to ensure that the MRF remains current. Alternatively, the model generation component 304 can update the MRF whenever a document is added, removed or updated or after a predetermined number of changes to the document data store 102. Model updating may be computationally intense. Accordingly, updates can be scheduled for times when the search tool less likely to be in use (e.g., after midnight). The details of model generation are discussed in detail below.

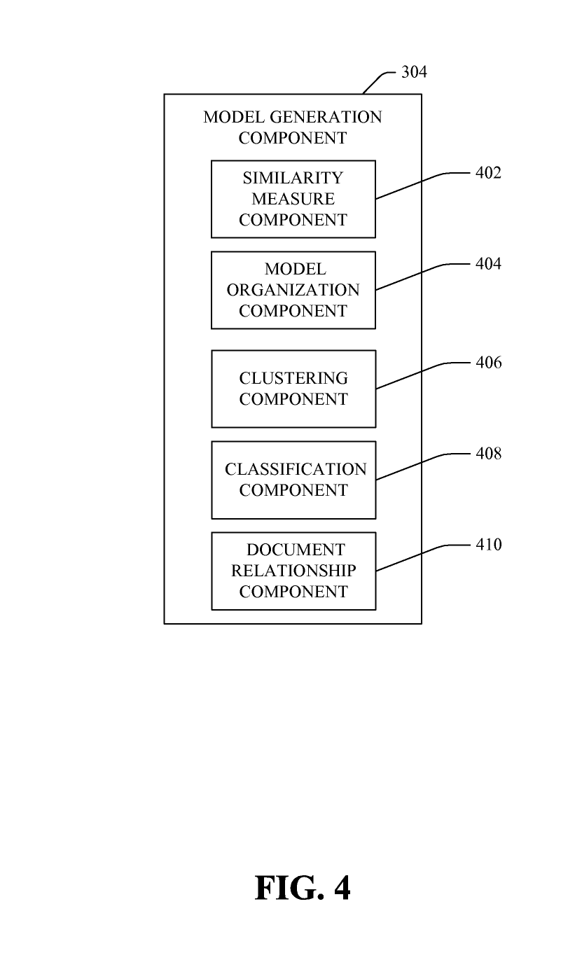

FIG. 4 depicts an aspect of the model generation component 304 in detail. The model generation component includes a similarity measure component 402 that is capable of generating a score indicative of the similarity of a pair of documents. Similarity can be measured using various methods and algorithms (e.g., term frequency, BM-25). The model organization component 404 can maintain these similarity scores to represent the document relationships.

The similarity measure component 304 can measure document similarity based upon presence of terms or words within the pair of documents. In particular, each document can be viewed as a “bag-of-words.” The appearance of words within each document is considered indicative of similarity of documents regardless of location or context within a document. Alternatively, syntactic models of each document can be created and analyzed to determine document similarity. Similarity measurement is discussed in further detail below.

The model generation component 304 can also utilize a clustering component 406 and/or a classification component 408 in building similarity models. Both the clustering component 406 and the classification component 408 subdivide the document set into subsets of documents that ideally share common traits. The clustering component 406 performs this subdivision based upon data clustering. Data clustering is a form of unsupervised learning, a method of machine learning where a model is fit to the actual observations. In this case, clusters would be defined based upon the document set. The classification component 408 can subdivide the document set using supervised learning, a machine learning technique for creating a model from training data. The classification component 408 can be trained to partition documents using a sample document. Classes would be defined based upon the sample set prior to evaluation of the document set.

Alternatively, the document set can be pre-clustered or classified prior to generation of a similarity model. For example, an independent indexing system can subdivide the document set before processing by the similarity ranking component. As new documents are added, the indexing system can incorporate such documents into the document groups.

When the document set is subdivided into groups, whether by a clustering component 406, a classification component 408 or an independent system, the similarity model can represent relationships among the groups rather than individual documents. Here, a node of the similarity model represents a group of documents and the distance between nodes or groups corresponds to similarity between document groups.

Similarity between groups can be based upon contents of all documents within the group. The similarity measure component 402 can generate a super-document for each document group. The super-document can include terms from all of the documents in the group and acts as a feature vector for the document group. Similarity between super-documents can be computed using any similarity measure. The model organization component 404 can maintain super-document similarity scores representing document group relationships.

When documents are grouped by either the clustering component 406 or the classification component 408, original document ranks should be adjusted based upon group similarity. For example, documents from groups that are deemed similar should have comparable rankings. In addition, documents that are within the same group should have similar rankings.

The model generation component 304 can also include a document relationship component 410 that reduces the number of similarity computations for similarity model generation. The document relationship component 410 can identify a set of related documents for each document within the document set. Related documents can be identified based upon the presence of certain key or important terms. For instance, for a first document on the subject of Sir Arthur Conan Doyle, important terms could include “Sherlock Holmes,” “Doctor Watson,” “Victorian England,” “Detectives” and the like. Any document within the document set that includes any one of those terms can be considered related to the first document. A document can be related to multiple documents and sets of related documents may overlap. For example, a second document regarding the fictional detective “Hercule Poirot” would be considered related to the first document, but may also be related to third document regarding Agatha Christie. Presumably, documents that do not share important terms are not similar.

Similarity computations can be limited by measuring similarity of documents only to related documents. For each document, the similarity measure component 402 would compute similarity only for related documents. This would eliminate computation of similarity for document pairs that do not share important terms.

In aspects, document similarity can be measured utilizing the BM-25 text retrieval model. For the BM-25 model, the number of times a term or word appears within a document, referred to as term frequency, can be used in measurement of document similarity. However, certain terms may occur frequently without truly representing the subject or topic of the document. To mitigate this issue, the term frequency dⱼ of a term j can be normalized using the inverse of number of times the term occurs in the set of documents, referred to as inverse document frequency dfⱼ of the term. Normalized term frequency xⱼ can be represented as follows:

xⱼ=dⱼ/dfⱼ (1)

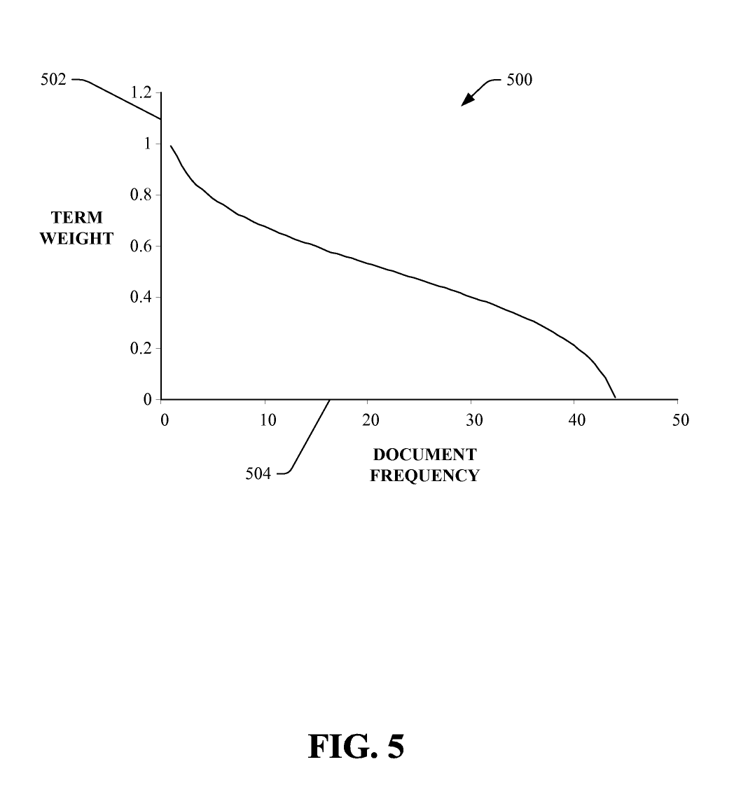

Referring now to FIG. 5, a graph 500 illustrating the relationship between term weight and term frequency is depicted. The vertical axis 502 represents the weight of a particular term in determining document similarity. Here, the weight has been normalized to values between zero and one. The horizontal axis 504 represents the number of documents in which the term occurs, where the total number of documents within the exemplary document corpus is equal to forty-five. As illustrated, the weight for a specific term should be roughly, inversely proportional to the number of documents in which the term occurs. For example, if a term appears in all documents of the set, the term provides little or no useful information regarding relationships among the documents.

Simple normalization may not adequately adjust for term frequency. Certain terms may be over-penalized based upon frequency of the term. Additionally, some terms that appear infrequently, but which are not critical to the subject of the documents, may be over-emphasized. Accordingly, while normalization can be utilized to adjust for frequency of terms, analysis that is more sophisticated may improve results.

Document similarity can be represented based upon a 2-Poisson model, where term frequencies within documents are modeled as a mixture of two Poisson distributions. Use of the 2-Poisson model is based upon the hypothesis that occurrences of terms in the document have a random or stochastic element. This random element reflects a real, but hidden distinction between documents that are on the subject represented by the term and those documents that are on other subjects. A first Poisson distribution represents the distribution of documents on the subject represented by the term and a second Poisson distribution, with a different mean, represents the distribution of document on other subjects.

This 2-Poisson distribution model forms the basis of BM-25 model. Ignoring repetition of terms in the query, term weights based on the 2-Poisson model can be simplified as follows:

wⱼ=(k₁+1)dⱼ/(k₁((1−b)+b dl/avdl)+dⱼ)log((N−dfⱼ+0.5)/(dfⱼ+0.5)) (2)

Here, j represents the term for which a document d is evaluated. Accordingly, dⱼ is equal to the frequency of term j within document, dfⱼ represents the document frequency of term j, dl is the length of the current document, avdl is the average document length within the set of documents, N is equal to the number of documents within the set, and both k and b are constants. The term and document frequencies are not normalized by the document length terms, dl and avdl, because unlike queries, document length can be a factor in document similarity. For instance, it is less likely that two documents will be considered similar if the first document is two lines long, while the second document is two pages long.

Each document within the document set can be represented by a feature vector based upon document terms. Based upon Equation (2) above, an exemplary feature vector representing a document, d, can be written as follows:

xⱼ=dⱼ/(1+k₁ dⱼ)log((N−dfⱼ+0.5)/(dfⱼ+0.5)) (3)

Here, constant k₁ can be set to a small value. The feature vector can be used to represent a document and the distance between document feature vectors can be used as a similarity measure.

Similarity between documents can be represented by a cosine measure. Using cosine measure to determine document similarity allows for differences in length of documents. The distance or similarity measure β_{xy} between documents x and y can be written as follows:

β_{xy} =x·y/∥x∥ ∥y∥ (4)

Here, x and y are feature vectors of documents x and y, respectively, formed utilizing Equation (3). The 2-norm or Euclidean norm of each of the feature vectors is represented by ∥x∥ and ∥y∥, respectively. If the constant, k₁, is assumed to be zero, distance between documents or similarity can also be represented as follows:

β_{xy}=dₓ W² d_{y}/∥Wx∥ ∥Wy∥ (5)

Here, dₓ and d_{y} are document frequency vectors of documents x and y. W is a diagonal matrix whose diagonal term is given as:

Wⱼⱼ=sqrt(log((N−dfⱼ+0.5)/(dfⱼ+0.5)) (6)

Consequently, similarity can be measured based upon document distance. Both the feature vectors used to represent documents as well as the measure of similarity can be implemented utilizing various methods to improve performance or reduce processing time.

Exemplary similarity measurement methods were analyzed based upon relative performance over a sample set. Typically, similarity measures that do not capture the semantic structure of documents are likely to suffer from various limitations. Experiments were conducted to see whether similarity measures determined in accordance with such algorithms were comparable to similarity scores as determined by humans.

For the experiment, a sample set of forty-five documents was selected from SQL Online books, a collection of document regarding structured query language available via the Internet. Five persons were asked to evaluate subsets of documents from the sample set and provide a similarity score for each pair of documents belonging to the given subset. Each individual was provided with a different subset, although the subsets did overlap to allow for estimation of person to person variability in similarity scoring. The correlation between similarity scores produced by individuals was 0.91. The correlation between scores generated utilizing the BM-25 model with a cosine measure was 0.67. Results for additional algorithms are illustrated in Table I:

TABLE I

| Comparison of Similarity Ranking Methods | Correlation |
|---|---|
| Person to person | .91 |
| Person to “Cosine, BM-25 model” | .67 |
| Person to “Cosine, Term Frequency” | .52 |
| Person to “Euclidean, Term Frequency” | .47 |

Here, the first row of the table indicates correlation of ranking performed by different people (e.g., 91). The second row indicates the correlation between similarity evaluations generated by humans and those generated using the BM-25 similarity algorithm and the cosine measure. The third row indicates correlation between similarity evaluations generated by humans and those generated based upon term frequency and the cosine measure. Finally, the fourth row indicates correlation between similarity evaluations generated by humans and those generated based upon a similarity algorithm based upon term frequency and the Euclidean measure. The different algorithms should be evaluated based upon relative performance rather than using absolute numbers.

The performance of the BM-25 similarity algorithm was further verified using an additional fifteen documents from SQL Online books evaluated by two individuals and 20 more documents from Microsoft Developer Network (MSDN) online, a collection of documents intended to assist software developers available via the Internet. The algorithm provides reasonable results for most documents.

Certain situations remained problematic for the BM-25 similarity algorithm during experiments. For example, documents regarding disparate topics, yet having similar formats had an artificially high similarity score. Such documents tended to include many common words that did not actually relate to the topic. While the similarity algorithm lessened the effect of such unimportant words, it did not completely remove the impact. Additionally, scores for extremely verbose documents were less accurate. Verbose documents had a relatively small number of keywords or important words and a great deal of free natural language text. Since semantic structure of the document was not captured for the experiment, similarity measure for such documents was reduced. Furthermore, the similarity algorithm was unable to utilize metadata in determining similarity. Metadata was critical in generating similarity scores for some documents. Humans typically attach a great deal of importance to title words or subsection titles. However, the BM-25 similarity algorithm can be adapted to recognize and utilize meta-data.

For many documents, similarity measured based upon the terms appearing in the document is more accurate than comparisons of actual phrasing. For instance, in certain textual databases (e.g., resume databases) semantics and formatting are relevantly unimportant. For such databases, the similarity algorithms described above may provide sufficient performance without semantic analysis.

Preliminary experiments have indicated that ranking systems utilizing a similarity model may return better search results than ranking systems that do not utilize similarity. Once document similarity has been measured and a set of original ranks has been generated, the ranks should be reevaluated based upon similarity. During experimentation, additional documents were retrieved based upon similarity and ranks of retrieved documents were recalculated. During testing, rank recalculation over a sample set performed satisfactorily.

A similarity model was generated for a MSDN data set including 11,480 documents. Ranks were calculated for sample queries such as “visual FoxPro,” “visual basic tutorial,” “mobile devices,” and “mobile SDK.” For such queries, the new similarity assisted ranking system returned better sets of documents. For example, in the original ranking some documents received high rankings, even though the highly ranked documents were not directed to the topic for which the search was conducted. However, when similarity was used to enhance the searches, additional documents were retrieved and ranked more highly than those original off-topic documents based upon similarity to relevant documents.

Search tool performance may be improved by utilizing more sophisticated similarity measures. For example, similarity measurement can be enhanced based upon analysis of location of terms within the document. Location of terms within certain document fields (e.g., title, header, body, footnotes) may indicate the importance of such terms. During similarity computations, terms that appear in certain sections of the document may be more heavily weighted than terms that appear in other document sections to reflect these varying levels of importance. For example, a term that appears in a document title may receive a greater weight than a term that appears within a footnote.

Information regarding type of document to be evaluated and/or document metadata can also be utilized to improve analysis of similarity. Document type can affect the relative importance of terms within a document. For example, many web page file names are randomly generated values. Accordingly, if the documents being evaluated are web pages, file names may be irrelevant while page titles may be very important in determining document similarity. Metadata may also influence document similarity. For example, documents produced by the same author may be more likely to be similar than documents produced by disparate authors. Various metadata and document type information can be used to enhance similarity measurement.

Semantic and syntactic structure can also be used to determine relevance of terms within a document. Document text can be parsed to identify paragraphs, sentences and the like to better determine the relevance of particular terms within the context of the document. It should be understood that the methods and algorithms for measurement of document similarity described herein are merely exemplary. The claimed subject matter is not limited in scope to the particular systems and methods of measuring similarity described herein.

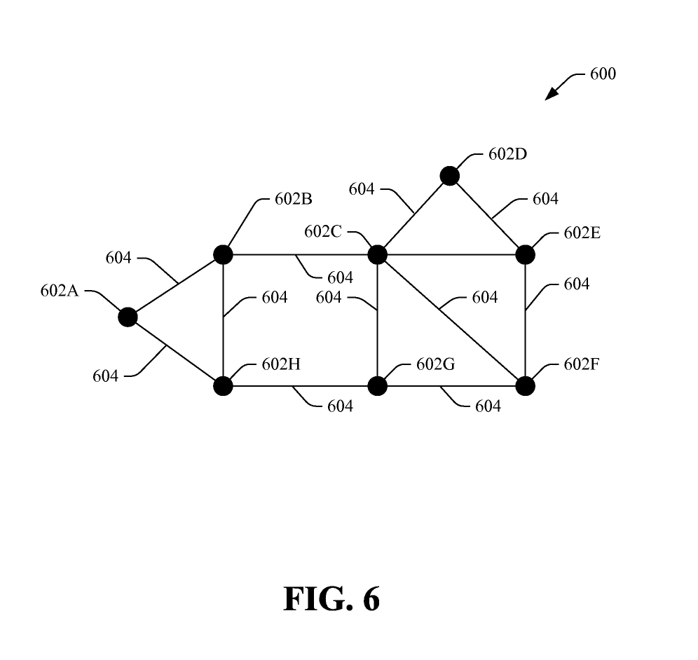

Turning now to FIG. 6, an exemplary graph 600 of a Markov Random Field is illustrated. A Markov Random Field is a type of Bayesian Network. Bayesian networks (both directed and undirected) constitute a large class of probabilistic graphical models. Markov Random Fields are particularly well-suited for representing similarity among documents. The model component can utilize a Markov Random Field to represent similarity among documents of the document set. For instance, for a set of eight documents, each document can be represented as a node 602A, 602B, . . . , 602H within the graph. Each document node 602A, 602B, . . . , 602H will have an associated original rank or score that can be adjusted based upon similarity. The vertices 604 connecting the documents can represent the similarity between the pair of connected documents, where distance corresponds to similarity measure or score.

Markov Random Fields are conditional probability models. Here, the probability of a rank of particular node 602A is dependent upon nearby nodes 602B and 602H. The rank or relevance of a particular document depends upon the relevance of nearby documents as well as the features or terms of the document. For example, if two documents are very similar, ranks should be comparable. In general, a document that is similar to documents having a high rank for a particular query should also be ranked highly. Accordingly, the original ranks of the documents should be adjusted while taking into account the relationships between documents.

Based upon the Markov Random Field model, new ranks for the documents can be computed based in part upon ranks of similar documents. In particular, the probability of a set of ranks r for the document set for a given query q can be represented as follows:

P(r|q)=(1/Z)exp(Σᵢ|rᵢ−r₀ᵢ|₁+μ Σ_{ij ε G}βᵢⱼ|rᵢ−rⱼ|) (7)

Here, r₀ is equal to the original or initial rank provided by the search tool and Z is a constant. The equation utilizes two penalty terms to ensure that the ranks do not change dramatically from the original ranks and to ensure similar documents are similarly ranked. Error is possible both in calculation of the original ranks and in computation of similarity; constants Z and μ can be selected to compensate for such error.

The first penalty term of Equation (7), referred to as the association potential, reflects differences between original ranks and possible adjusted ranks

Σᵢ|rᵢ−r₀ᵢ|₁ (7A)

The difference between the adjusted rank and the original rank is summed over the set of documents. This first term requires the new rank rᵢ to be close to the original rank r₀ᵢ by applying a penalty if the adjusted rank moves away from that original rank.

The probability of distribution of the ranks can be viewed as a Markov Random Field network, given original ranks as determined by a set of feature vectors. The probability that a set of rank assignments accurately represents relevance of the set of documents decreases if two similar documents are assigned different ranks. The second penalty term of Equation (7), referred to as the interaction potential, illustrates this relationship:

μ Σ_{ij ε G}βᵢⱼ|rᵢ−rⱼ| (7B)

βᵢⱼ is indicative of the similarity between documents i and j and can be computed using equations (4) and (5) above. This similarity measure, βᵢⱼ, is multiplied by the difference in rank between documents. If two documents are very similar and the ranks of those documents are dissimilar, the interaction potential will be relatively large. Consequently, the larger the disparities between document rankings and document similarity, the greater the value of the interaction potential term. The interaction potential term explicitly models the discontinuities in the ranks as a function of the similarity measurements between documents. In general, documents that are shown to be similar should have comparable ranks.

There are many alternative formulations of the interaction potential. For example, the interaction potential can also be represented as follows:

μ Σ_{ij ε G}βᵢⱼ|rᵢ−rⱼ|² (7C)

Here, the interaction potential utilizes a standard least squares penalty. Least squares penalties are typically used when the assumed noise of a distribution is Gaussian. However, for similarity measurement noise may not be Gaussian. There may be errors or inaccuracies involved both in computation of similarity of documents and/or in the initial ranking by the search system. Accordingly, there may be document pairs with widely different similarity measures and rankings. Unfortunately, least squares estimation can be non-robust for outlying values.

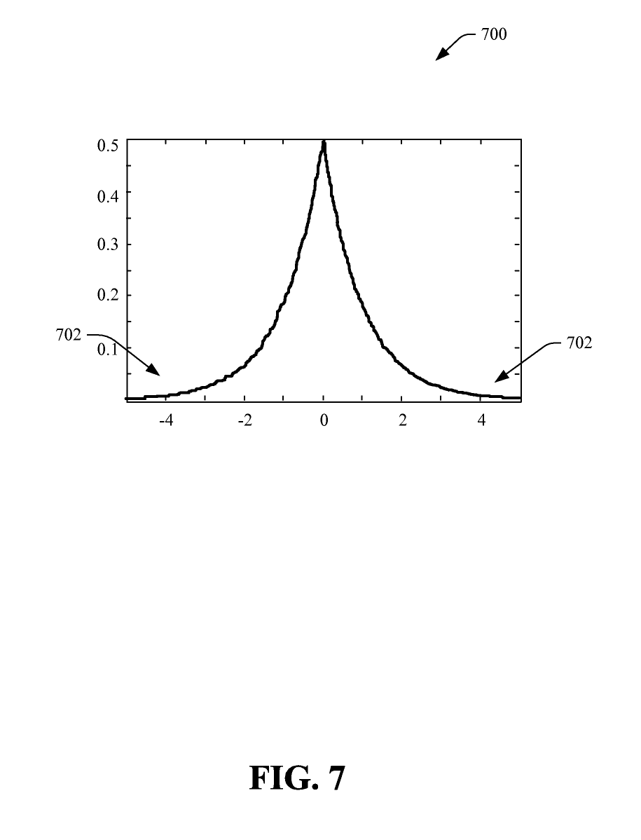

FIG. 7 includes a graph 700 of a Laplacian distribution for a one-dimensional variable or 1-norm penalty. As can be seen, the distribution has a long tails 702. This distribution would allow for outlying values based upon mistakes either in rank assignment or in judging similarity. Consequently, a 1-norm penalty may be preferable to a least squares penalty. The original distribution originates from a 2-possion model, which results in a non-convex penalty. However, a 1-norm penalty is the closest approximation to the 2-poisson model while making solving of the equation a convex problem. In the simplest case (when all the distances or similarities are equal to one (e.g., β=1), the rank of the new document is the median of the rank of the original documents that were connected.

Turning once again to the rank model described by Equation (7), if original ranks can be determined precisely, then the first term of the equation, referred to as the association potential, can be replaced by a 2-norm penalty corresponding to Gaussian errors. The resulting overall distribution can be represented as follows:

P(r|q)=(1/Z)exp(Σᵢ|rᵢ−r₀ᵢ|₂+μ Σ_{ij ε G}βᵢⱼ|rᵢ−rⱼ|) (8)

### Equation (8) may be preferable if the original ranks are relatively accurate, reducing the possibility of outlying distribution values that would be heavily penalized in a Gaussian distribution.

The Maximum Likelihood Estimation (MLE) statistical method can be used to solve a similarity model and determine adjusted ranks. The MLE solution for this model corresponds to solving a Second Order Cone Program (SOCP), a special case of Semi-Definite Programming (SDP). SOCP solvers are widely available on the Internet and may be used to resolve the ranking problem.

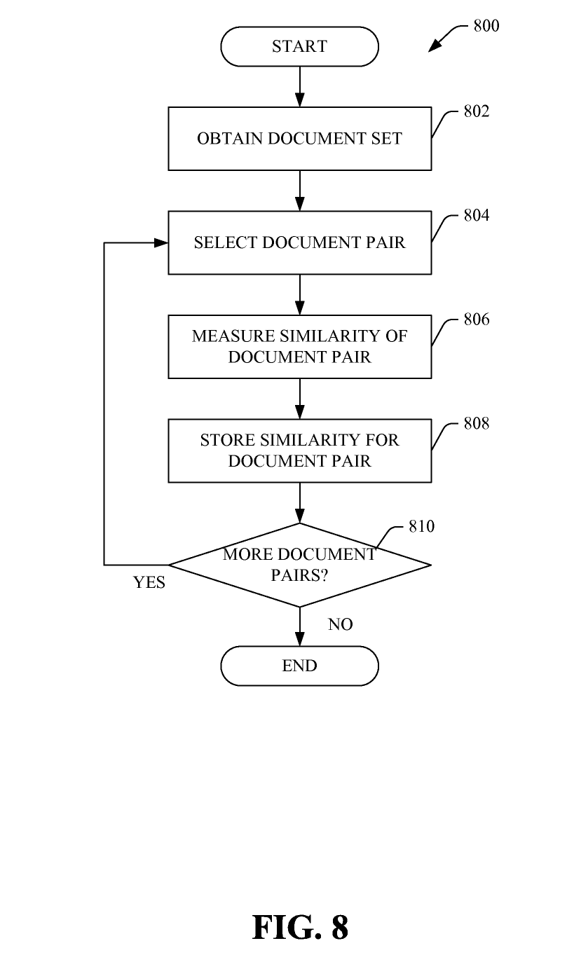

Referring now to FIG. 8, a methodology 800 for generating a similarity model is illustrated. At 802, a set or collection of items or documents is obtained. At 804, a pair of documents from the collection can be selected for comparison. Eventually, each document should be compared to every other document within the collection. Therefore, pairs should be methodically selected to ensure that each possible pair is selected in turn. A similarity measure can be computed for the selected pair of documents at 806. The similarity measure should reflect the correlation of subjects and concepts between the selected pair of documents. Similarity and can be measured using any of the algorithms described in detail above or any other suitable method or algorithm.

At 808, the similarity measure can be stored and used to model document relationships. In particular, the measure corresponds to distance between the pair of document nodes for a Markov Random Field similarity model. A determination is made as to whether there are additional pairs of documents to be evaluated at 810. If yes, the process returns to 804, where the next pair of documents is selected. If no, and the process terminates. Upon termination, the similarity scores necessary for a complete similarity model have been generated.

The methodology illustrated in FIG. 8 can be computationally expensive for large data sets. Similarity would be measured for each possible pair of documents. If a collection includes large quantities of documents, time and processing power to generate the model may become excessive. While similarity models need only be generated once for use with multiple queries, if additional documents are added or existing documents are modified, the model may need to be updated. An out of date similarity model may result in degraded performance for a search system. However, several different methods can reduce the number of computations required to generate the similarity model.

Data clustering of documents can reduce the number of computations and therefore the time required to generate the similarity model. Various clustering algorithms can be used to group or cluster documents. After document clustering, similarity between documents clusters can be measured. Here, each node of the Markov Random Field corresponds to a document cluster instead of an individual document. The distance between nodes or clusters would be indicative of similarity between clusters. Similarity between clusters can be measured by defining a super-document for each cluster containing the text of all documents within the cluster. The super-document acts as a feature vector for the cluster. Similarity between clusters can be calculated utilizing any similarity measuring algorithms to compute similarity between the super-documents.

If data clustering is used to generate a similarity model, original ranks for documents should be adjusted based upon defined clusters as well as similarities between clusters. For example, documents within the same cluster should have similar ranks. In addition, documents in clusters that are very similar should have similar ranks.

Document classification systems and/or methods can also be utilized in conjunction with the similarity model to facilitate searching and/or ranking of documents. Documents can be separated into categories or classes. For example, a machine learning system can be trained to evaluate documents and define categories for a training set, prior to classifying the document set. Once the document set has been subdivided, similarity between individual categories can be measured. Here, each node of a Markov Random Field similarity model would represent a category of documents. As with data clustering, a super-document representing a category can be compared with a super-document representing a second category to generate a similarity score. The super-document for a category can include text of all documents in the category.

When data classification is used to generate the similarity model, document ranks should be adjusted based upon ranks of other documents within the category as well as similarities between categories. For example, documents within the same category should have similar ranks. In addition, documents in categories that are very similar should have comparable ranks in the search results.

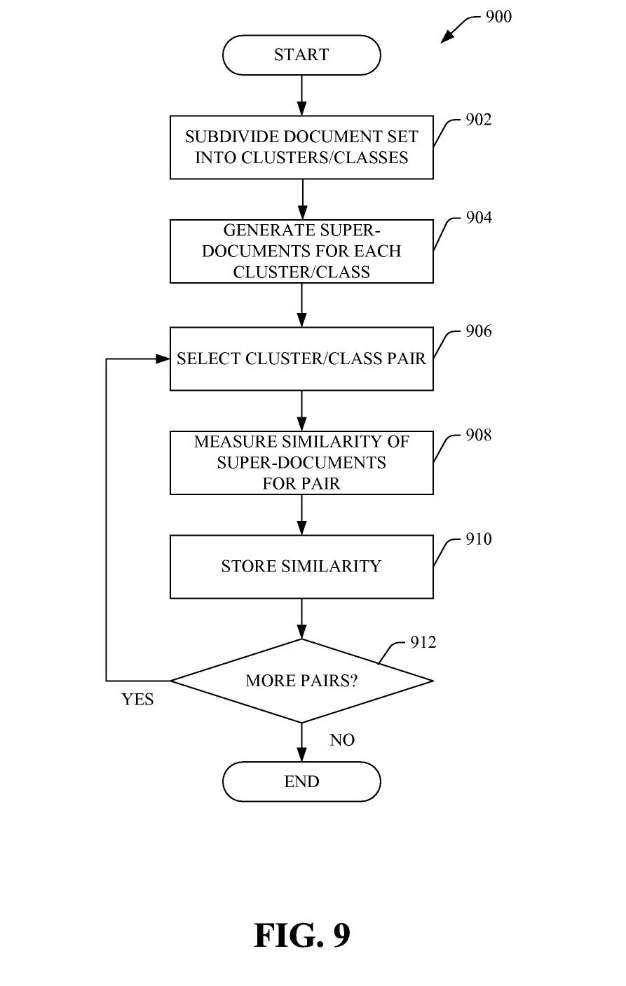

Referring now to FIG. 9, a methodology 900 for generating a similarity model utilizing either data clustering or classification is illustrated. At 902, a set of documents is subdivided into clusters or classes utilizing a clustering algorithm or classification method. After the collection of documents has been grouped into either clusters or classes, a super-document is generated for each group at 904. The super-document can include all terms for every document within the class or cluster. The super-document should at least include all important terms for the documents. At 906, a pair of clusters or classes is selected. The super-documents for the pair are utilized to measure similarity of the pair at 908.

At 910, the similarity measure can be maintained, effectively defining distance between cluster or class nodes in a Markov Random Field. A determination is made as to whether there are additional pairs of clusters or classifications to be evaluated at 912. If yes, the process returns to 906, where the next pair of clusters or classes is selected. If no, the similarity model for the set of documents is complete and the process terminates.

In yet another aspect, generation of a similarity model can be facilitated by identifying a set of related documents for each document within the document set. Related documents can be identified based upon the presence of certain key or important terms. Any document within the document set that includes any one of those terms would be considered related to the first document. Presumably, any document that does not include any of the important terms would not be considered similar. Similarity computations can be limited by measuring similarity of each document only to related documents. This would eliminate computation of similarity for document pairs that do not share important terms.

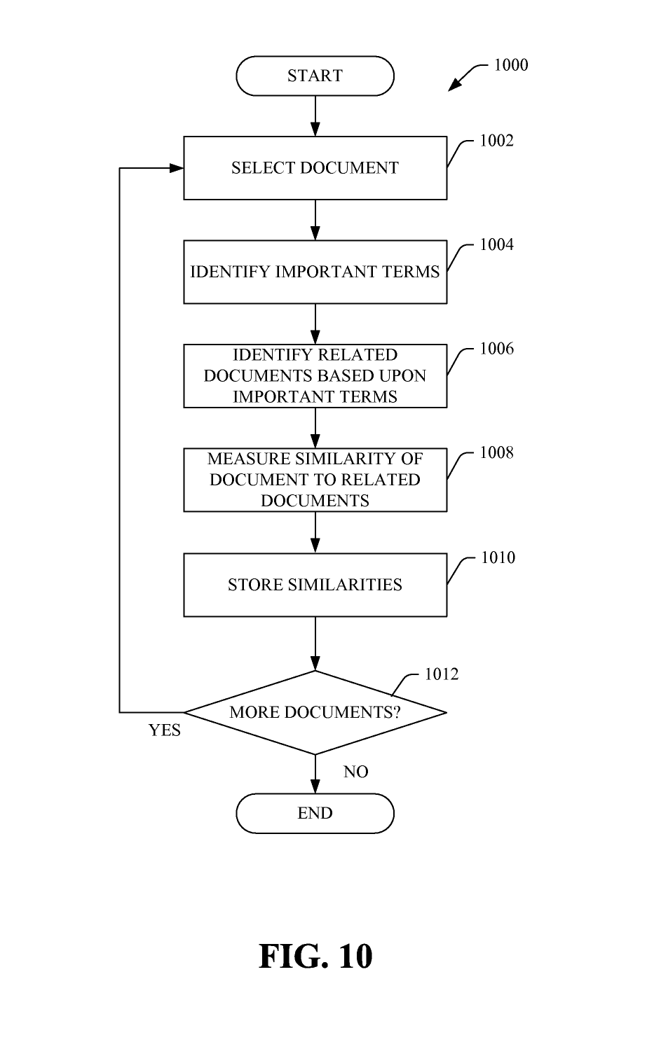

Referring now to FIG. 10, a methodology 1000 for generating a similarity model based upon likelihood of similarity is illustrated. At 1002, a document is selected for evaluation. The “important” words or terms of the document are identified at 1004. Term importance can be based upon term frequency, syntactic and/or semantic analysis, metadata or any other criteria. At 1006, related documents that include one or more of the important terms of the first document are identified. Similarity between the first document and each of the related documents can be measured at 1008. These similarities can be stored at 1010. At 1012, a determination is made as to whether there are additional documents to evaluate. If yes, the process returns to 1002, where the next document is selected for processing. If no, the process terminates. In this case, the Markov Random Field similarity model may be incomplete, since the distance between each node or document is not necessarily computed. However, the distances that are likely to be most relevant are calculated.

Once the similarity model has been generated and the original ranking of documents has been determined, the model can be solved to generate the adjusted rankings. In particular, the model can be implemented using linear program approximation. The rank r from Equation (7) above can be estimated using pseudo-Maximum Likelihood (ML). Maximum Likelihood for such probabilistic models is a NP-hard problem. The likelihood of ranks r can be expressed as:

l(r)=log P(r|q) (9)

The likelihood of a set of ranks, l(r), is equal to the logarithm of probability of r given query q. Logarithm is a monotonic function; if x increases then log x increases. Therefore, maximizing the logarithm of the probability, log P(r|q), is equivalent to maximizing likelihood of ranks r, l(r). Turning once again to Equation (7), because logarithm is the inverse of the exponential function, exp( ), taking the logarithm of the probability represented by equation cancels the exponential function and removes the constant Z. Consequently, solving for the “best” set of ranks r, by minimizing the two penalty terms of Equation (7), can be represented as follows:

r_{best}=minᵣ Σᵢ|rᵢ−r₀ᵢ|+μ Σ_{ij ε G}βᵢⱼ|rᵢ−rⱼ|) (9.5)

For a ranking set: r=[r₁ r₂ r₃ . . . r_{N}] for N documents. Minimizing likelihood of ranks l(r) with free variables r is equivalent to the following convex optimization problem:

$$\begin{matrix}{min}_{r} & {\sum }_{i} {ξ}_{1 i} + μ {\sum }_{ij} {ξ}_{2 ij} & \\ s . t . & \vert {r}_{i} - {r}_{0 i} \vert \leq {ξ}_{1 i} & i = 1 , 2 , … , N \\ & {\sum }_{ij ε G} {B}_{ij} \vert {r}_{i} - {r}_{j} \vert \leq {ξ}_{2 ij} & i = 1 , 2 , … , N ; j = 1 , 2 … N , i \neq j\end{matrix} \qquad ( 10 )$$

N is equal to the total number of documents and G is an undirected weighted graph of the documents, in this case the similarity model. Additionally, μ is a free parameter that may be learned by cross-validation. Generally, a small value for μ will result in lesser effect of similarity on ranking. Conversely, a large value for μ will cause similarity to have a greater effect on the adjusted ranking. The value of μ can be set to a constant. Alternatively, a slider or other control can be provided in a user interface and used to adjust μ dynamically.

In addition, the adjusted rankings can be constrained to prevent decreases in rankings of the original set of documents selected based upon the query. The convex optimization problem can be rewritten as follows:

$$\begin{matrix}{min}_{r} & {\sum }_{i} {ξ}_{1 i} + μ {\sum }_{ij} {ξ}_{2 ij} & \\ s . t . & \vert {r}_{i} - {r}_{0 i} \vert \leq {ξ}_{1 i} & i = 1 , 2 , … , N \\ & {r}_{m} - {r}_{0 m} \leq 0 & m = {k}_{1} , {k}_{2} , … , {k}_{M} \\ & {\sum }_{ij ε G} {B}_{ij} \vert {r}_{i} - {r}_{j} \vert \leq {ξ}_{2 ij} & i = 1 , 2 , … , N ; j = 1 , 2 … N , i \neq j\end{matrix} \qquad ( 11 )$$

### Here, m is the original set of identified documents, k₁, k₂, . . . , k_{M}. The minimizations illustrated in Equations (10) and (11) can be implemented as linear programs that can be solved using available libraries.

The aforementioned systems have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Additionally, it should be noted that one or more components may be combined into a single component providing aggregate functionality or divided into several sub-components. The components may also interact with one or more other components not specifically described herein but known by those of skill in the art.

Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

For purposes of simplicity of explanation, methodologies that can be implemented in accordance with the disclosed subject matter were shown and described as a series of blocks. However, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter. Additionally, it should be further appreciated that the methodologies disclosed throughout this specification are capable of being stored on an article of manufacture to facilitate transporting and transferring such methodologies to computers. The term article of manufacture, as used, is intended to encompass a computer program accessible from any computer-readable device, carrier, or media.

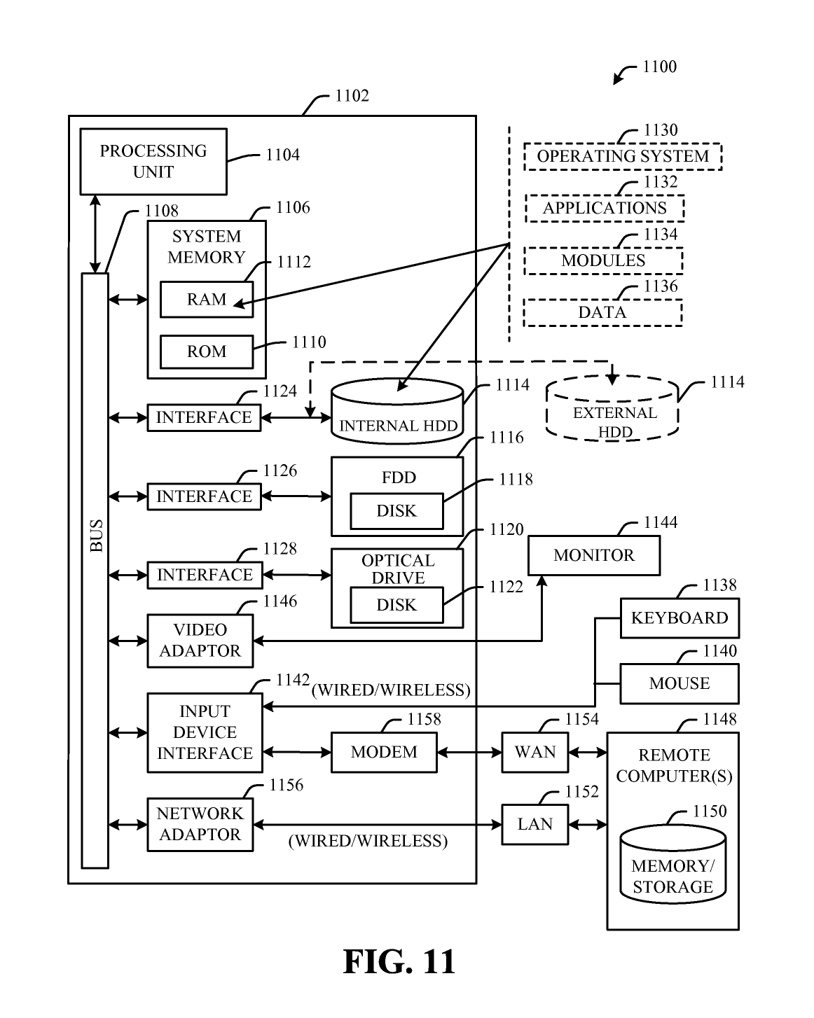

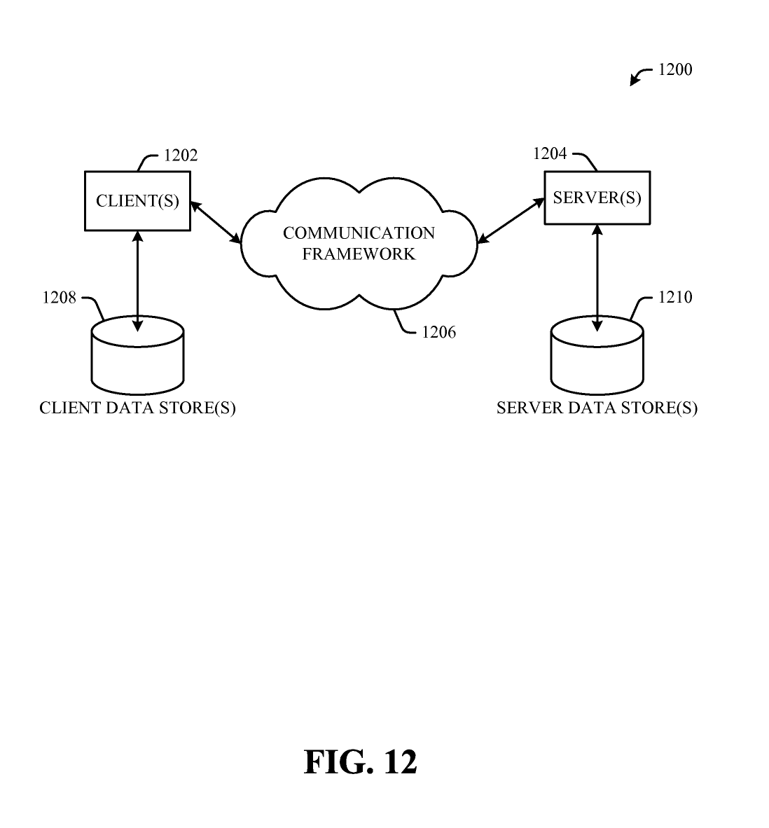

In order to provide a context for the various aspects of the disclosed subject matter, FIGS. 11 and 12 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the system and methods disclosed herein also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics and the like. The illustrated aspects may also be practiced in distributed computing environments where tasks are performed by remote processing devices that are linked through a communications network. However, some, if not all aspects of the systems and methods described herein can be practiced on stand-alone computers. In a distributed computing environment, program modules may be located in both local and remote memory storage devices.

With reference again to FIG. 11, the exemplary environment 1100 for implementing various aspects of the embodiments includes a mobile device or computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures may also be employed as the processing unit 1104.

The system memory 1106 includes read-only memory (ROM) 1110 and random access memory (RAM) 1112. A basic input/output system (BIOS) is stored in a non-volatile memory 1110 such as ROM, EPROM, EEPROM, which BIOS contains the basic routines that help to transfer information between elements within the computer 1102, such as during start-up. The RAM 1112 can also include a high-speed RAM such as static RAM for caching data.

The computer or mobile device 1102 further includes an internal hard disk drive (HDD) 1114 (e.g., EIDE, SATA), which internal hard disk drive 1114 may also be configured for external use in a suitable chassis (not shown), a magnetic floppy disk drive (FDD) 1116, (e.g., to read from or write to a removable diskette 1118) and an optical disk drive 1120, (e.g., reading a CD-ROM disk 1122 or, to read from or write to other high capacity optical media such as the DVD). The hard disk drive 1114, magnetic disk drive 1116 and optical disk drive 1120 can be connected to the system bus 1108 by a hard disk drive interface 1124, a magnetic disk drive interface 1126 and an optical drive interface 1128, respectively. The interface 1124 for external drive implementations includes at least one or both of Universal Serial Bus (USB) and IEEE 1194 interface technologies. Other external drive connection technologies are within contemplation of the subject systems and methods.

The drives and their associated computer-readable media provide nonvolatile storage of data, data structures, computer-executable instructions, and so forth. For the computer 1102, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods for the embodiments of the data management system described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. It is appreciated that the systems and methods can be implemented with various commercially available operating systems or combinations of operating systems.

A user can enter commands and information into the computer 1102 through one or more wired/wireless input devices, e.g., a keyboard 1138 and a pointing device, such as a mouse 1140. Other input devices (not shown) may include a microphone, an IR remote control, a joystick, a game pad, a stylus pen, touch screen, or the like. These and other input devices are often connected to the processing unit 1104 through an input device interface 1142 that is coupled to the system bus 1108, but can be connected by other interfaces, such as a parallel port, an IEEE 1194 serial port, a game port, a USB port, an IR interface, etc. A display device 1144 can be used to provide a set of group items to a user. The display devices can be connected to the system bus 1108 via an interface, such as a video adapter 1146.

The mobile device or computer 1102 may operate in a networked environment using logical connections via wired and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wired/wireless connectivity to a local area network (LAN) 1152 and/or larger networks, e.g., a wide area network (WAN) 1154. Such LAN and WAN networking environments are commonplace in offices and companies, and facilitate enterprise-wide computer networks, such as intranets, all of which may connect to a global communications network, e.g., the Internet.

When used in a LAN networking environment, the computer 1102 is connected to the local network 1152 through a wired and/or wireless communication network interface or adapter 1156. The adaptor 1156 may facilitate wired or wireless communication to the LAN 1152, which may also include a wireless access point disposed thereon for communicating with the wireless adaptor 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wired or wireless device, is connected to the system bus 1108 via the serial port interface 1142. In a networked environment, program modules depicted relative to the computer 1102, or portions thereof, can be stored in the remote memory/storage device 1150. It will be appreciated that the network connections shown are exemplary and other means of establishing a communications link between the computers can be used.

The computer 1102 is operable to communicate with any wireless devices or entities operatively disposed in wireless communication, e.g., a printer, scanner, desktop and/or portable computer, PDA, communications satellite, any piece of equipment or location associated with a wirelessly detectable tag (e.g., a kiosk, news stand, restroom), and telephone. The wireless devices or entities include at least Wi-Fi and Bluetooth™ wireless technologies. Thus, the communication can be a predefined structure as with a conventional network or simply an ad hoc communication between at least two devices.

Wi-Fi allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

FIG. 12 is a schematic block diagram of a sample-computing environment 1200 with which the systems and methods described herein can interact. The system 1200 includes one or more client(s) 1202. The client(s) 1202 can be hardware and/or software (e.g., threads, processes, computing devices). The system 1200 also includes one or more server(s) 1204. Thus, system 1200 can correspond to a two-tier client server model or a multi-tier model (e.g., client, middle tier server, data server), amongst other models. The server(s) 1204 can also be hardware and/or software (e.g., threads, processes, computing devices). One possible communication between a client 1202 and a server 1204 may be in the form of a data packet adapted to be transmitted between two or more computer processes. The system 1200 includes a communication framework 1206 that can be employed to facilitate communications between the client(s) 1202 and the server(s) 1204. The client(s) 1202 are operably connected to one or more client data store(s) 1208 that can be employed to store information local to the client(s) 1202. Similarly, the server(s) 1204 are operably connected to one or more server data store(s) 1210 that can be employed to store information local to the servers 1204.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” are used in either the detailed description or the claims, such terms are intended to be inclusive in a manner similar to the term “comprising” as “comprising” is interpreted when employed as a transitional word in a claim.

What is claimed is:

1. A system for ordering items, comprising:
a search component that obtains an original ranking of at least a subset of a plurality of items;
a similarity model component that utilizes a Markov Random Field as a representation of relationships among the plurality of items; and
a rank adjustment component that generates an adjusted ranking of at least the subset as a function of the original ranking and the representation.

2. The system of claim 1, further comprising a similarity measure component that determines at least one similarity score for a pair of items, the representation is based at least in part upon the at least one similarity score.

3. The system of claim 2, the at least one similarity score is based at least in part upon a BM-25 model for measuring text-based similarity.

4. The system of claim 2, the at least one similarity score is based at least in part upon semantics of the pair of items.

5. The system of claim 2, the at least one similarity score is based at least in part upon metadata associated with the pair of items.

6. The system of claim 1, further comprising:
a model generator component that subdivides the plurality of items into a plurality of clusters; and
a similarity measure component that determines at least one similarity score for a pair of the clusters, the representation is based at least in part upon of the similarity score.

7. The system of claim 1, further comprising:
a model generator component that classifies the plurality of items into a plurality of categories; and
a similarity measure component that determines at least one similarity score for a pair of the categories, the representation is based at least in part upon of the similarity score.

8. The system of claim 1, the rank adjustment component utilizes a linear program in adjusted ranking generation.

9. The system of claim 8, the rank adjustment component utilizes at least one of a Second Order Cone Program (SOCP) and a quadratic program in adjusted ranking generation.

10. The system of claim 1, further comprising:
a model generator component that identifies at least one item related to a first item; and
a similarity measure component that determines at least one similarity score for the first item and the related item, the representation is based at least in part upon of the similarity score.

11. A method of facilitating item retrieval from a set of items, comprising:
obtaining initial search results of at least for the set of items; and
updating the initial search results as a function of a Markov Random Field modeling similarity of items within the set.

12. The method of claim 11, further comprising:
performing an initial search of the set of items based at least in part upon a query; and
providing the updated results for presentation to a user.

13. The method of claim 11, further comprising:
determining a similarity score for at least one pair of items of the set of items; and
constructing the Markov Random Field model based upon the similarity score.

14. The method of claim 13, the similarity score is based at least in part upon presence of a common term in the item pair.

15. The method of claim 14, the similarity score is based at least in part upon a semantic analysis of the item pair.

16. The method of claim 14, the similarity score is based at least in part metadata associated with the item pair.

17. The method of claim 11, further comprising:
utilizing a clustering algorithm to group the items into a plurality of clusters;
determining a similarity score for at least one pair of clusters; and
constructing the Markov Random Field model based upon the similarity score.

18. The method of claim 11, further comprising:
classifying the items into a plurality of categories;
determining a similarity score for at least one pair of categories; and
constructing the Markov Random Field model based upon the similarity score.

19. A system for ordering a set of items, comprising:
means for receiving an initial ordering of at least a subset of the items; and
means for modifying the initial ordering based at least in part upon a Markov Random Field model of item similarity based at least in part upon text of the items.

20. The system of claim 19, further comprising:
means for measuring the item similarity as a function of item text; and
means for generating a Markov Random Field model utilizing the measurement of item similarity.
